(19) United States
(12) Patent Application Publication
(10) Pub. No.: US 2009/0151188 A1
(43) Pub. Date: Jun. 18, 2009

(54) Clothes treating apparatus

(75) Inventors: Jung Wook Moon, Changwon-si (KR); Dae Yun Park, Changwon-si (KR); Sog Kie Hong, Changwon-si (KR); Jong Seok Kim, Changwon-si (KR); Seung Gyu Ryu, Changwon-si (KR); Hye Yong Park, Changwon-si (KR); Chang Gyu Choi, Changwon-si (KR); Dong Won Kim, Changwon-si (KR)

Correspondence Address: MCKENNA LONG & ALDRIDGE LLP, 1900 K STREET, NW, WASHINGTON, DC, 20006, US

(73) Assignee: LG ELECTRONICS, Seoul (KR)

(21) Appl. No.: 12/219,947

(22) Filed: Jul. 30, 2008

(30) Foreign Application Priority Data
Aug. 3, 2007 (KR) 10-2007-0078122
Aug. 3, 2007 (KR) 10-2007-0078173

(51) Int. Cl. F26B 25/08; F26B 21/00; F26B 25/00

(52) U.S. Cl. 34/218; 34/72; 34/235

(57) ABSTRACT

A clothes treating apparatus is disclosed. The clothes treating apparatus includes a cabinet having an accommodating space to accommodate clothes, a hot air supplying device to heat air and supply hot air to the accommodating space, and a communicating unit to communicate the accommodating space with the outside. The communicating unit includes a restraining part to restrain exhaust of hot air supplied from the hot air supplying device.

This application claims the benefit of Korean Patent Application No. 10-2007-0078173, filed on Aug. 3, 2007 and Korean Patent Application No. 10-2007-0078122, filed on Aug. 3, 2007 which is hereby incorporated by reference as if fully set forth herein.

### BACKGROUND OF THE INVENTION

1. Field of the Invention

The present invention relates to a clothes treating apparatus, and more particularly, to a clothes treating apparatus capable of preventing a child from being locked therein and enhancing performance thereof.

2. Discussion of the Related Art

In general, clothes treating apparatuses include washing machines for washing clothes, laundry dryers for drying washed laundry, washing machines combined with a dryer having both washing and drying functions, and the like. There have been developed refreshers for refreshing clothes according to a recent high standard of living. A refresher functions to refresh clothes by supplying dry air to the clothes stored therein.

Therefore, a clothes treating apparatus such as a refresher may have an airtight structure in order to refresh clothes stored therein and further to remove moisture. Such an airtight structure can enhance performance of refreshing and drying clothes.

However, the airtight structure has also a problem such that a child who accidentally gets therein cannot escape. In other words, in a case where a child accidentally enters a clothes treating apparatus and closes a door, she/he is unable to open the door from the inside because the clothes treating apparatus is designed to form an airtight structure. Thus, there is a risk that a child locked in the clothes treating apparatus is suffocated.

### SUMMARY OF THE INVENTION

Accordingly, the present invention is directed to a clothes treating apparatus that substantially obviates one or more problems due to limitations and disadvantages of the related art.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve the objects and other advantages and in accordance with the purpose of the invention, as embodied and broadly described herein, a clothes treating apparatus comprises: a cabinet having an accommodating space to accommodate clothes; a hot air supplying device to heat air and supply hot air to the accommodating space; and a communicating unit to communicate the accommodating space with the outside, the communicating unit including a restraining part to restrain exhaust of hot air supplied from the hot air supplying device.

Preferably, the clothes treating apparatus further comprises a circulation duct to supply hot air from the hot air supplying device to the accommodating space. Preferably, the communicating unit is formed at the circulation duct, and when the hot air supplying device is in a non-operating state, the communicating unit is operated to communicate the accommodating space with the outside.

Preferably, the restraining part is opened by a weight thereof in a non-supply mode of hot air.

Preferably, the restraining part includes a ventilation door mounted to the circulation duct so as to be pivoted at a predetermined angle. In a supply mode of hot air, the ventilation door is closed by hot air. In a non-supply mode of hot air, the ventilation door is pivoted by a weight thereof to be opened.

Preferably, the restraining part includes a ventilation hole to communicate the accommodating space of the cabinet with the outside, an opening/closing part to selectively open the ventilation hole, and a control unit to control the opening/closing part.

Preferably, the opening/closing part includes a door or a valve mounted to the ventilation hole.

Preferably, when operation of the hot air supplying device is stopped, the control unit controls the opening/closing part to be opened.

Preferably, the control unit controls the opening/closing part to be opened in a predetermined time after operation of the hot air supplying device is stopped.

Preferably, the control unit controls the opening/closing part to be periodically opened.

Preferably, the communicating unit includes a first hole formed at an inner surface of the cabinet, and a second hole formed at an outer surface of the cabinet to be connected to the first hole. The restraining part connects the first hole and the second hole, and includes at least one communicating channel formed in a bent shape.

Preferably, the clothes treating apparatus further comprises at least one projection portion provided in the communicating channel so that the communicating channel connecting the first hole and the second hole is formed to be bent.

Preferably, the clothes treating apparatus further comprises a plurality of partition walls formed in the communicating channel. The partition walls are formed with communicating holes to connect the first hole and the second hole, and the communicating holes are arranged alternately to the communicating holes adjacent thereto.

Preferably, the communicating unit is formed near a corner of the cabinet.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a perspective view illustrating a clothes treating apparatus according to an exemplary embodiment of the present invention;

FIG. 2 is a perspective view schematically illustrating a constitution of a machine room shown in FIG. 1;

FIG. 3 is a sectional view illustrating a constitution of a first embodiment of a communicating unit shown in FIG. 1;

FIG. 4 is a sectional view illustrating a constitution of a second embodiment of a communicating unit shown in FIG. 1;

FIG. 5 is a sectional view illustrating a constitution of a third embodiment of a communicating unit shown in FIG. 1;

FIG. 6 is a sectional view illustrating a constitution of a fourth embodiment of a communicating unit shown in FIG. 1; and

FIG. 7 is a sectional view taken along line VII-VII of FIG. 6.

### DETAILED DESCRIPTION OF THE INVENTION

Reference will now be made in detail to the preferred embodiments of the present invention associated with a clothes treating apparatus, examples of which are illustrated in the accompanying drawings. Wherever possible, the same reference numbers will be used throughout the drawings to refer to the same or like parts.

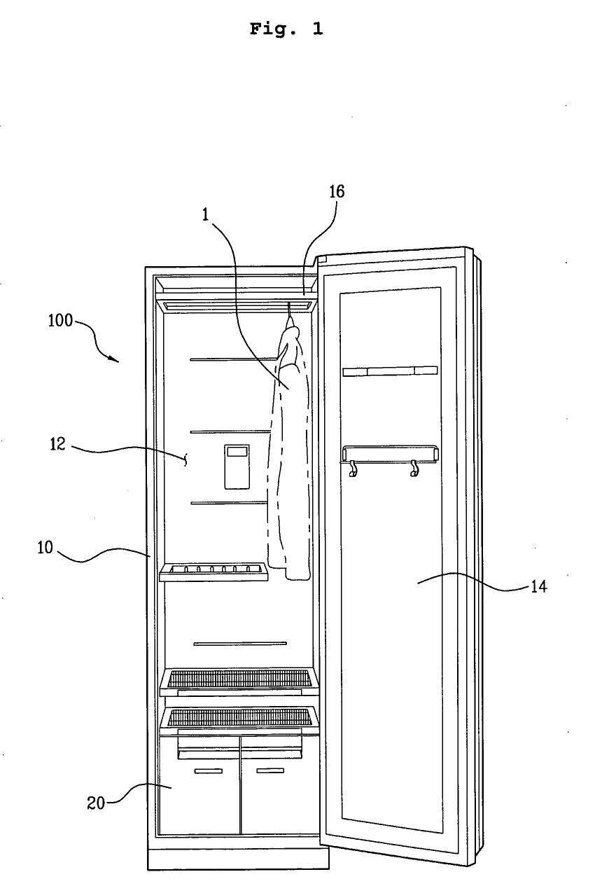

FIG. 1 is a front view illustrating a clothes treating apparatus according to an exemplary embodiment of the present invention. Although a refresher, which functions to refresh clothes by supplying hot air to the clothes, will be exemplified as a clothes treating apparatus in the following description, the present invention is not limited to a refresher. The present invention can also be applied to other clothes treating apparatuses which can be equipped with a heat pump and a moisture supplying device (which will be described later).

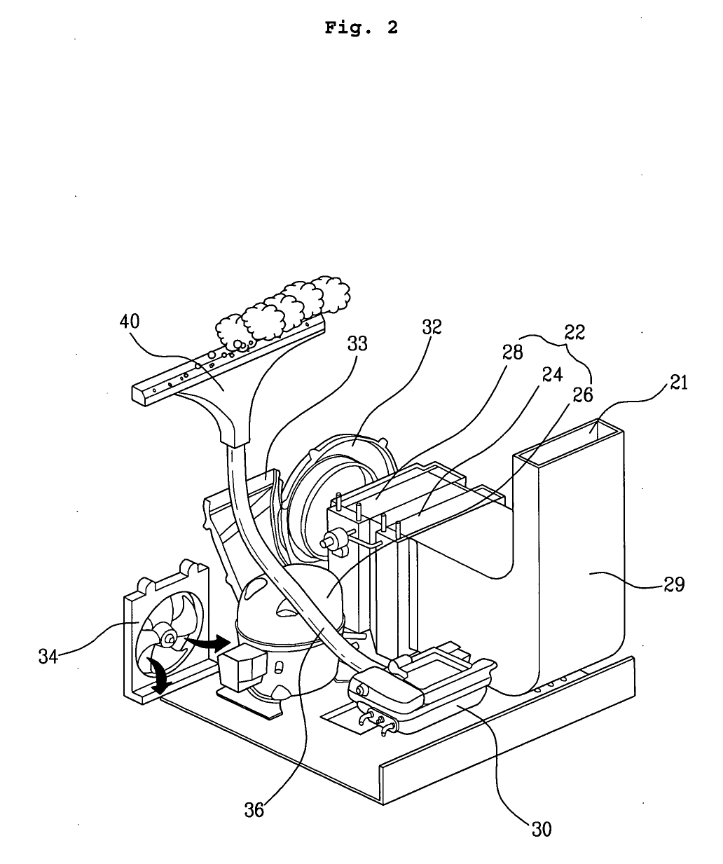

Referring to FIG. 1, a clothes treating apparatus 100 according to this embodiment may comprise a cabinet 10 formed with an accommodating space 12 to accommodate a clothes 1 therein, a hot air supplying device 22 (refer to FIG. 2) to supply hot air to the accommodating space 12, and a communicating unit to communicate the accommodating space 12 with the outside while inhibiting the hot air supplied from the hot air supplying device 22 from being exhausted outside. The clothes treating apparatus 100 according to this embodiment may further comprise a moisture supplying device 30 (refer to FIG. 2) to selectively supply moisture into the accommodating space 12.

All constitutional components described later are provided at the cabinet 10, and the accommodating space 12 is formed in the cabinet 10 to accommodate clothes. The accommodating space 12 selectively communicates with the outside by a door 14. Supporting bars 16, on which the clothes 1 is hung, are provided in the accommodating space 12. Because the constitution for supporting the clothes 1 is well known in this art, detailed description thereof will be omitted.

A machine room 20, in which the hot air supplying device 22 or the moisture supplying device 30 for selectively supplying hot air or moisture to the accommodating space 12, may be formed in the cabinet 10. Preferably, the machine room 20 is positioned below the accommodating space 12, and the aforementioned hot air supplying device 22 or moisture supplying device 30 is mounted in the machine room 20. The reason for positioning the machine room 20 at the lower portion of the cabinet 10 is that the hot air or the steam supplied to the accommodating space 12 has a tendency to rise up. Accordingly, it is preferred that the machine room 20 is positioned at the lower portion of the cabinet 10 to supply hot air or steam to the above.

FIG. 2 is a perspective view schematically illustrating an inner constitution of the machine room 20. For convenience of explanation, only the constitutional components of the heat pump 22 and the moisture supplying device 30 are illustrated in FIG. 2, and the pipe lines connecting the constitutional components are not illustrated in FIG. 2.

Referring to FIG. 2, the machine room 20 may contain the heat pump 22 as a hot air supplying device for supplying hot air to the accommodating space 12 (refer to FIG. 1) or the moisture supplying device 30 for supplying moisture to the accommodating space 12.

The heat pump 22 as a hot air supplying device of this embodiment has similarity to a heat pump used in an air conditioning apparatus. The heat pump 22 includes an evaporator 24, a compressor 26, a condenser 28 and an expansion valve (not shown), through which a refrigerant circulates, so as to dehumidify and heat air. While evaporating in the evaporator 24, the refrigerant absorbs latent heat from ambient air, so that the air is cooled down and moisture in the air is condensed and removed. When the refrigerant is condensed in the condenser 28 via the compressor 26, the refrigerant emits latent heat to the ambient air, thereby heating the ambient air. As such, the evaporator 24 and the condenser 28 serve as heat exchangers, and the air introduced into the machine room 20 sequentially passes through the evaporator 24 and the condenser 28 to be dehumidified and heated, and then is supplied to the accommodating space 12.

The air heated by the heat pump 22 may have a temperature slightly lower than air heated by a conventional heater, however there is an advantage that the air can be dehumidified without using a separate dehumidifying device. Therefore, the air re-supplied to the accommodating space 12 by the heat pump 22 is comparatively “low-temperature dry air” (here, the “low temperature” is not used as a meaning of an absolutely low temperature, but is used as a meaning that the air from the heat pump 22 corresponds to heated air however has a relatively low temperature in comparison with air heated by a conventional manner). Accordingly, the air supplied from the heat pump 22 has a temperature lower than hot air in a conventional clothes treating apparatus, however the dehumidified air can be supplied without a separate dehumidifying device, thereby easily drying and refreshing clothes. Although it has been described that this embodiment adopts an air heating manner using a heat pump, this embodiment is not limited to such an air heating manner. The present invention can also adopt other air heating means, such as a heater using gas or electricity, as a hot air supplying device.

An air inlet hole 21, through which the air in the accommodating space 12 flows into the machine room 20, is formed at a front top portion of the machine room 20. A circulation duct 29 is provided to connect the air inlet hole 21, the evaporator 24, the condenser 28 and a fan 32, so as to define an air flow channel. The air introduced into the machine room 20 through the air inlet hole 21 and the circulation duct 29 is dehumidified and heated while passing through the heat pump 22, and then is supplied to the accommodating space 12 by the fan 32.

Although not illustrated in the drawings, a filter may be provided in the air inlet hole 21. If a filter is provided in the air inlet hole 21, foreign substances included in the air flowing to the machine room 20 from the accommodating space 12 are filtered out, so that clean air can be supplied to the accommodating space 12.

The moisture supplying device 30 for selectively supplying moisture to the accommodating space 12 is provided in the machine room 20. Preferably, the moisture supplying device comprises a steam generating device for generating and supplying steam into the accommodating space 12. The steam of high temperature supplied to the accommodating space 12 from the steam generating device 30 may have effects of removing wrinkles of clothes, sterilizing, and refreshing clothes by swelling the clothes. The time of ejecting steam from the steam generating device 30 can be determined diversely. It is preferred that steam is ejected before hot air from the heat pump 22 is supplied. This is for more efficiently drying clothes.

The steam generating device 30 includes a heater (not shown) for heating water, so as to generate steam by heating water and supply the steam to the accommodating space 12. A water supply source for supplying water to the steam generating device 30 may be configured as an exterior water tap, or a container type water supply source provided in a portion of the machine room 20. Preferably, the container type water supply source is removably mounted, so that a user can remove the water supply source from the machine room 20 to fill water in the water supply source, and can remount the water supply source in the machine room 20.

The steam generated from the steam generating device 30 is supplied to the accommodating space 12 through a steam hose 36 and a steam ejecting unit 40. In order to prevent temperature drop of the steam or condensation of the steam while the steam passes through the steam hose 36, it is preferable to set a length of the steam hose 36 as short as possible. In a case where the machine room 20 is positioned below the accommodating space 12, it is preferred that the steam ejecting unit 40 supplies steam through the top of the machine room 20, that is, through the bottom of the accommodating space 12.

A circulation fan 34 may be provided in a rear portion of the machine room 20. The circulation fan 34 serves to supply external air into the machine room 20, so as to prevent excessive rise of a temperature in the machine room 20 due to operation of the heat pump 22 and the steam generating device 30.

In order to prevent the hot air injected into the accommodating space 12 from leaking out, it is preferred that the clothes treating apparatus as constituted above is designed to have an airtight structure when the door 14 (refer to FIG. 1) is closed.

However, the airtight structure of the accommodating space 12 when the door 14 is closed has a problem of incapability of ventilation. In other words, if clothes is stored in the cabinet 10 (refer to FIG. 1) with the door closed for a long time, odor in the cabinet 10 cannot be exhausted outside, and permeates the clothes. Further, if an airtight state is maintained for a long time, the inner space of the cabinet 10 becomes moldy, which may cause damage to the clothes.

Also, if a child accidentally enters the cabinet 10 and is locked therein by closing the door 14, she/he is unable to open the door 14 and to escape from the cabinet 10, which may cause a risk that a child locked in the cabinet 10 is suffocated.

In this regard, in a case of storing clothes in the cabinet 10 for a long time, it is required to ventilate the cabinet 10 periodically so as to supply fresh air into the cabinet 10. Also, it is required to design the accommodating space 12 to have a non-airtight structure even when the door is closed. However, it is very inconvenient for a user to open the door 14 manually at every time for ventilation. Further, if a user is away from home for a long time because of travel, for example, the ventilation cannot be achieved at all.

In order to prevent the above problems, the clothes treating apparatus according to this embodiment further comprises a communicating unit to introduce external air into the accommodating space 12. By virtue of the communicating unit for introducing external air into the accommodating space 12, the accommodating space 12 and the circulation duct 29 do not form an airtight structure so that a person who accidentally gets in the accommodating space 12 is prevented from being suffocated, and fresh air is supplied into the cabinet 10. In addition, the clothes treating apparatus according to this embodiment has characteristics that while external air is allowed to enter the accommodating space 12 and the circulation duct 29, hot air or steam supplied to the accommodating space 12 is prevented from leaking out, which will be explained in detail hereinafter.

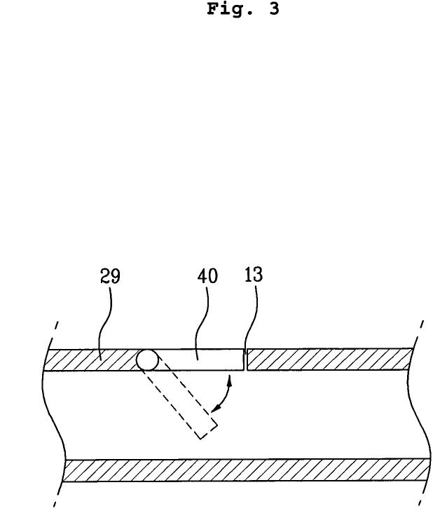

FIG. 3 is a sectional view schematically illustrating a constitution of a communicating unit according to a first embodiment of the present invention.

Referring to FIG. 3, a communicating unit according to this embodiment includes a ventilation door 40 which is coupled to the circulation duct 29 so as to be pivoted at a predetermined angle. When hot air is supplied, the ventilation door 40 is closed by the hot air. When hot air is not supplied, the ventilation door 40 is pivoted by its own weight to be opened.

In particular, the ventilation door 40 is pivotably mounted to a predetermined portion of the circulation duct 29. As shown in FIG. 3, it is preferred that the ventilation door 40 is kept in a horizontal state when closing an opening portion 13. Accordingly, the opening portion 13, as shown in FIG. 3, is preferably formed at an upper portion of the circulation duct 29.

Because the hot air flowing through the circulation duct 29 moves by the operation of the fan 32 (refer to FIG. 2), the hot air has a pressure higher than a predetermined value. Therefore, when the hot air flows through the circulation duct 29 by the operation of the fan 32, the ventilation door 40 is not pivoted down, and is kept to close the opening portion 13 by the pressure of the hot air, as shown by a solid line of FIG. 3.

On the other hand, when the operation of the hot air supplying device is terminated and the hot air supply by the fan 32 is not performed, the ventilation door 40 is pivoted down by its own weight, as shown by an arrow direction of FIG. 3, and opens the opening portion 13. Accordingly, external air is introduced into the circulation duct 29 through the opened opening portion 13, and is supplied to the accommodating space 12, to thereby achieve the ventilation and prevent the accommodating space 12 from being airtight.

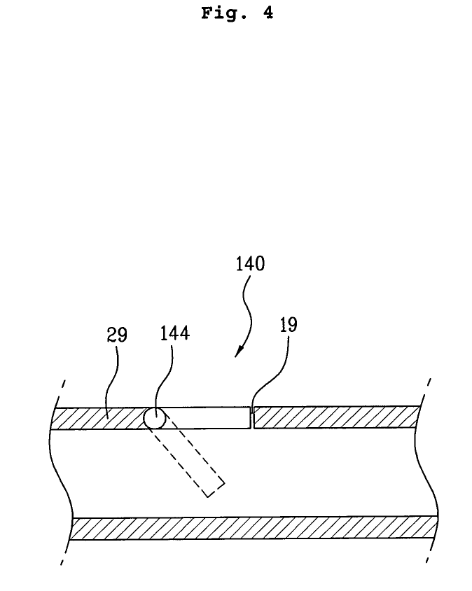

FIG. 4 is a sectional view schematically illustrating a constitution of a communicating unit according to a second embodiment of the present invention. A communicating unit of this embodiment has difference from the communicating unit of the previous embodiment shown in FIG. 3, in that the communicating unit is controlled to selectively open an opening portion by a control unit.

Referring to FIG. 4, a communicating unit of a second embodiment may include an opening portion 19 for communicating the accommodating space 12 of the cabinet 10 with the outside, an opening/closing part 140 for selectively opening the opening portion 19, and a control unit (not shown) for controlling the opening/closing part 140. In this embodiment, the opening/closing part 140 is controlled to selectively open the opening portion by the control unit, to thereby achieve the ventilation.

In particular, the opening portion 19 serves to communicate the accommodating space 12 with the outside. Preferably, the opening portion 19 is formed at a predetermined portion of the circulation duct 29 to communicate the accommodating space 12 with the outside.

The opening/closing part 140 includes a door 142 pivotably mounted to a predetermined portion of the opening portion 19, and a driving part 144 which is controlled to rotate the door 142 by the control unit. Accordingly, the driving part 144 is operated by the control unit, and the door 142 is pivoted by the operation of the driving part 144, to open or close the opening portion 19.

In particular, when the operation of the hot air supplying device is terminated and the hot air supply is not performed, the control unit controls the driving part 144 to operate to open the door 142, so that external air is introduced into the circulation duct 29. In such a case, it is preferred that after the operation of the hot air supplying device is terminated, the control unit controls the door 142 to be opened in a predetermined time, e.g., 5 to 10 minutes. This is because if the door 142 is opened immediately after the operation of the hot air supplying device is terminated, the hot air remaining in the accommodating space 12 is exhausted outside through the opening portion 19, and thus the drying of clothes is not smoothly achieved.

Also, it is preferred that the control unit controls the door 142 to be opened at a predetermined period, e.g., for 5 minutes with an interval of 30 minutes. If the door 142 is kept in an opened state while hot air is not supplied, there is possibility that external foreign substances such as dust enter the cabinet 10 and damage clothes. Accordingly, it is preferred that the control unit controls the door 142 to be periodically opened so as to minimize introduction of foreign substances into the cabinet 10 while realizing the ventilation.

Although it is illustrated in FIG. 4 that the door 142 communicates the accommodating space 12 with the outside, the present invention is not limited to such a structure and can be diversely modified. For example, the present invention may employ a valve for communicating the accommodating space 12 with the outside.

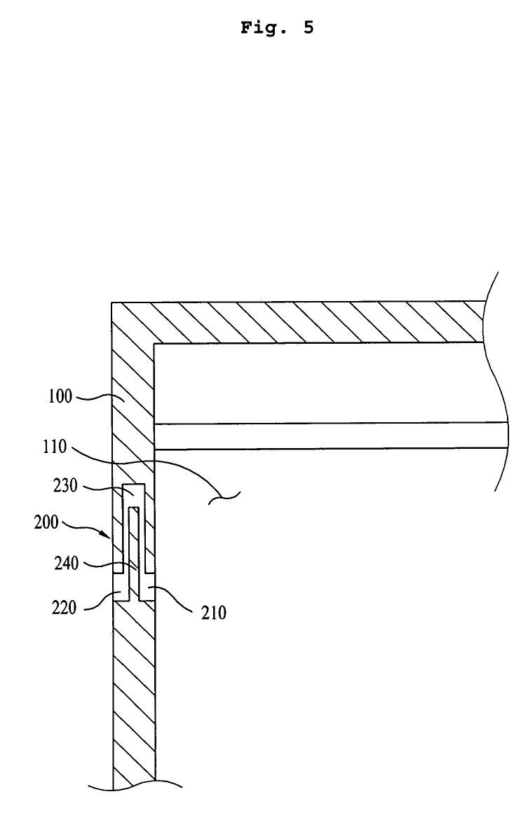

FIG. 5 is a partial side-sectional view illustrating a cabinet formed with a communicating unit according to a third embodiment of the present invention.

Referring to FIG. 5, a communicating unit 200 of a third embodiment includes a first hole 210 formed at an inner surface of the cabinet 100, and a second hole 220 formed at an outer surface of the cabinet 100. A communicating channel 230 is formed between the first hole 210 and the second hole 220, through which air flows.

The communicating channel 230 serves to communicate the accommodating space 110 in the cabinet 100 with the outside. In order to prevent the hot air or the steam supplied to the accommodating space 110 from leaking out, the communicating channel 230 is formed to be bent at one point or more. In order to form the bent communicating channel 230, at least one projection portion 240 is provided along the channel.

The projection portion 240 is provided in the communicating channel 230 between the first hole 210 and the second hole 220, so that the communicating channel 230 is formed to be bent. Such a projection portion 240 functions as resistance to the hot air or the steam flowing through the communicating channel 230. Accordingly, although the accommodating space 110 communicates with the outside by the communicating channel 230, excessive leakage of the hot air or the steam supplied to the accommodating space 110 is prevented.

The projection portion 240 may be provided in a single number, and may also be provided in plural numbers to form the communicating channel 230 in a zigzag shape so as to further decrease the outflow amount of air from the first hole 210 to the second hole 220 and thereby enhance the leakage-preventing effect.

Preferably, the communicating unit 200 for communicating the inside of the cabinet 100 with the outside is formed near a corner of the cabinet 100. This is because when steam or hot air is supplied to the cabinet 100, an inner region near the corner of the cabinet 100 forms a so-called “dead zone”, to which the smallest amount of steam or hot air is supplied. Therefore, if the communicating unit 200 is formed near such a “dead zone”, it is possible to maximize the effect of preventing leakage of the steam or the hot air from the cabinet 100.

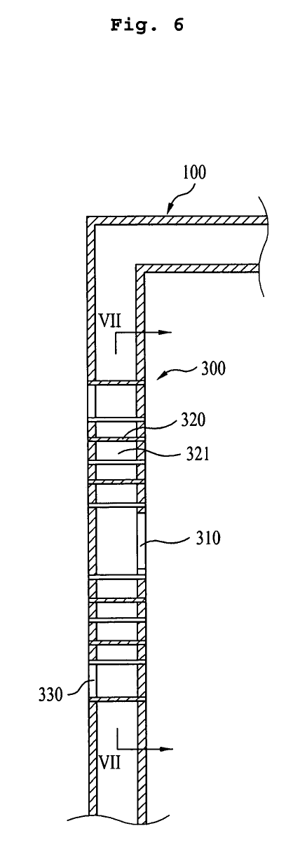

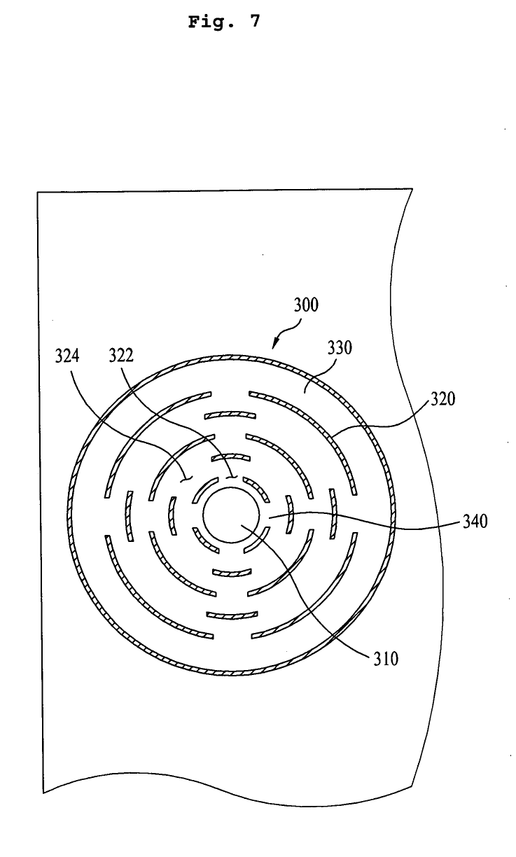

FIG. 6 is a partial side-sectional view illustrating a cabinet formed with a communicating unit according to a fourth embodiment of the present invention, and FIG. 7 is a sectional view taken along line VII-VII of FIG. 6. A communicating unit of a fourth embodiment has difference from the communicating unit of the third embodiment in a method of forming a communicating channel to be bent, which will be explained in detail hereinafter.

Referring to FIGS. 6 and 7, a communicating unit 300 of a fourth embodiment includes a plurality of partition walls 320, so as to form a communicating channel 340 to be bent. The partition walls 320, as shown in FIGS. 6 and 7, may be formed in a concentric circle shape centering on a first hole 310, and a second hole 330 may be formed along an outer surface of one of the partition walls 320.

The partition walls 320 may be formed with communicating holes 322 and 324 for defining a communicating channel 340 connecting the first hole 310 and the second hole 330. In other words, the communicating channel 340 is formed along the communicating holes 322 and 324 formed at the partition walls 320 from the first hole 310, and is connected to the second hole 330.

In such a case, in order to form the communicating channel 340 to be bent, it is preferred that the communicating holes 322 and 324 formed at the partition walls 320 are positioned alternately to each other. In other words, as shown in FIG. 7, each of the first communicating holes 322 and each of the second communicating holes 324 are not aligned with each other in a radial direction from the first hole 310, and are arranged alternately to each other in a radial direction so as to form the communicating channel 340 to be bent. As such, if the communicating holes 322 and 324 are arranged alternately to each other, the communicating channel 340 connecting the communicating holes 322 and 324 is formed to be bent in a so-called “maze structure”. Accordingly, similar to the aforementioned embodiments, although the communicating unit 300 of this embodiment communicates the inside of the cabinet 100 with the outside, excessive leakage of the hot air or the steam supplied to the cabinet 100 is prevented.

The communicating unit is not limited to the above-described structure, and can be modified diversely.

As described above, the clothes treating apparatus according to the present invention can prevent leakage of hot air or steam from the accommodating space, can prevent deterioration of efficiency of the clothes treating apparatus by allowing external air to be introduced into the accommodating space, and can prevent a safety accident.

As apparent from the above description, the clothes treating apparatus according to the present invention includes the communicating unit for communicating the accommodating space with the outside, thereby preventing a person who accidentally gets in the accommodating space from being suffocated.

Further, because external air is allowed to be introduced into the accommodating space, the performance of the clothes treating apparatus can be enhanced.

Still further, by virtue of the communicating unit for communicating the accommodating space with the outside, the inner space of the clothes treating apparatus can be prevented from being odorized.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A clothes treating apparatus comprising:
a cabinet having an accommodating space to accommodate clothes;
an air supplying device to heat air and supply hot air to the accommodating space; and
a communicating unit to communicate the accommodating space with the outside, the communicating unit including a restraining part to restrain exhaust of hot air supplied from the hot air supplying device.

2. The clothes treating apparatus according to claim 1, further comprising:
a circulation duct to supply hot air from the hot air supplying device to the accommodating space,
wherein the communicating unit is formed at the circulation duct, and
when the hot air supplying device is in a non-operating state, the communicating unit is operated to communicate the accommodating space with the outside.

3. The clothes treating apparatus according to claim 2, wherein the restraining part is opened by a weight thereof in a non-supply mode of hot air.

4. The clothes treating apparatus according to claim 3, wherein the restraining part includes a ventilation door mounted to the circulation duct so as to be pivoted at a predetermined angle,
and wherein in a supply mode of hot air, the ventilation door is closed by hot air, and
in a non-supply mode of hot air, the ventilation door is pivoted by a weight thereof to be opened.

5. The clothes treating apparatus according to claim 2, wherein the restraining part includes:
a ventilation hole to communicate the accommodating space of the cabinet with the outside;
an opening/closing part to selectively open the ventilation hole; and
a control unit to control the opening/closing part.

6. The clothes treating apparatus according to claim 5, wherein the opening/closing part includes a door or a valve mounted to the ventilation hole.

7. The clothes treating apparatus according to claim 6, wherein when operation of the hot air supplying device is stopped, the control unit controls the opening/closing part to be opened.

8. The clothes treating apparatus according to claim 7, wherein the control unit controls the opening/closing part to be opened in a predetermined time after operation of the hot air supplying device is stopped.

9. The clothes treating apparatus according to claim 7, wherein the control unit controls the opening/closing part to be periodically opened.

10. The clothes treating apparatus according to claim 1, wherein the communicating unit includes:
a first hole formed at an inner surface of the cabinet; and
a second hole formed at an outer surface of the cabinet to be connected to the first hole,
and wherein the restraining part connects the first hole and the second hole, and includes at least one communicating channel formed in a bent shape.

11. The clothes treating apparatus according to claim 10, further comprising:
at least one projection portion provided in the communicating channel so that the communicating channel connecting the first hole and the second hole is formed to be bent.

12. The clothes treating apparatus according to claim 10, further comprising:
a plurality of partition walls formed in the communicating channel,
wherein the partition walls are formed with communicating holes to connect the first hole and the second hole,
and wherein the communicating holes are arranged alternately to the communicating holes adjacent thereto.

13. The clothes treating apparatus according to claim 10, wherein the communicating unit is formed near a corner of the cabinet.

14. The clothes treating apparatus according to claim 1, further comprising a moisture supplying device to supply the moisture to the accommodating space.

15. The clothes treating apparatus according to claim 14, wherein the moisture supplying device comprises a steam generating device to generate steam and supply steam to the accommodating space.
